(19) United States
(12) Patent Application Publication
(10) Pub. No.: US 2020/0320633 A1
(43) Pub. Date: Oct. 8, 2020

(54) METHOD AND SYSTEM FOR CONSTRUCTING THEMATIC INVESTMENT PORTFOLIO

(71) Applicant: JPMorgan Chase Bank, N.A., New York, NY (US)

(72) Inventors: Mustafa Berkan SESEN, London (GB); Yazann ROMAHI, Oxford (GB); Ravit Efraty MANDELL, Larchmont, NY (US); Amir ZABET-KHOSOUSI, Princeton Junction, NJ (US); Jennifer RABOWSKY, New York, NY (US); Joe STAINES, New York, NY (US)

(73) Assignee: JPMorgan Chase Bank, N.A., New York, NY (US)

(21) Appl. No.: 16/839,292

(22) Filed: Apr. 3, 2020

Related U.S. Application Data
(60) Provisional application No. 62/830,094, filed on Apr. 5, 2019.

(51) Int. Cl. G06Q 40/06; G06F 16/2452; G06Q 30/00; G06Q 50/26; G06Q 30/02; G06F 40/20

(52) U.S. Cl. CPC G06Q 40/06; G06F 16/24522; G06Q 30/018; G06N 20/00; G06Q 30/0282; G06F 40/20; G06Q 50/265

(57) ABSTRACT

A method for facilitating a construction of a rank-ordered list of companies based on a theme is provided. The method includes identifying a plurality of companies associated with at least one stock exchange; determining search terms that relate to the theme; and constructing a query based on the search terms. For each company, the query is applied to a first set of company-specific textual sources and documents, in order to determine a textual relevance score, and the query is also applied to a second set of sources that relate to company-specific revenue data, in order to determine a revenue exposure score. The two scores are then combined into a composite score, and the companies are rank-ordered based on the respective composite scores. The rank-ordered list may be used for constructing a thematic investment portfolio.

### CROSS-REFERENCE TO RELATED APPLICATION

This application claims the benefit of U.S. Provisional Patent Application Ser. No. 62/830,094, filed Apr. 5, 2019, which is hereby incorporated by reference in its entirety.

### BACKGROUND

### 1. Technical Field

The present disclosure relates to the field of constructing and managing investment portfolios. More particularly, the present disclosure relates to a method and system for facilitating a construction of an investment portfolio based on a theme by analyzing textual information and revenue data for candidate companies.

### 2. Background

An investment portfolio is typically constructed for a purpose of maximizing projected investor profit. However, due to the inherent uncertainties of markets, a determination as to which types of investments are likely to perform well is quite subjective, and varies widely from investor to investor. In this regard, many investors may desire to focus their priorities on a theme, such as an emerging technology/business sector, a demographic shift, or a societal objective.

For an investor that desires to construct a thematic portfolio, there may be a significant amount of research required in order to obtain in-depth domain and stock-specific knowledge that would provide the investor with sufficient information to achieve the thematic goal. In this aspect, the present inventors have recognized that there is a need for a systematic way of analyzing the relevance of a particular company with respect to a theme, in order to facilitate an efficient construction of such a portfolio.

### SUMMARY

The present disclosure, through one or more of its various aspects, embodiments, and/or specific features or sub-components, provides, inter alia, various systems, servers, devices, methods, media, programs, and platforms for facilitating a construction of an investment portfolio based on a theme by analyzing textual information and revenue data for candidate companies.

According to an aspect of the present disclosure, a method for facilitating a construction of a rank-ordered list of companies based on a theme is provided. The method is implemented by at least one processor. The method includes: identifying a plurality of companies, each company within the plurality of companies being associated with a respective tradable stock; determining, for each of the plurality of companies, a respective first plurality of sources that relate to company-specific textual data and a respective second plurality of sources that relate to company-specific revenue data; determining at least one search term that relates to the theme; using each of the determined at least one search term to query, for each of the plurality of companies, the respective first plurality of sources that relate to company-specific textual data; calculating, for each of the plurality of companies, a respective first score based on a result of the first query: using each of the determined at least one search term to query, for each of the plurality of companies, the respective second plurality of sources that relate to company-specific revenue data; calculating, for each of the plurality of companies, a respective second score based on a result of the second query; and determining, for each of the plurality of companies, a respective composite score based on a combination of the respective first score and the respective second score.

The determining of at least one search term that relates to the theme may include determining at least one single word that relates to the theme.

The determining of at least one search term that relates to the theme may include determining at least one two-word phrase that relates to the theme.

The determining of at least one search term that relates to the theme may include determining at least one three-word phrase that relates to the theme.

The method may further include augmenting the first query by determining a plurality of words that relate to the determined at least one search term, determining a plurality of phrases that relate to the determined at least one search term, determining a plurality of topics that relate to the determined at least one search term, and using the determined plurality of words, the determined plurality of phrases, and the determined plurality of topics to augment the query.

The method may further include using at least one natural language processing technique with respect to the determined plurality of words, the determined plurality of phrases, and the determined plurality of topics in order to augment the first query. The at least one natural language processing technique may include at least one from among a word association technique and a co-occurrence analysis technique.

The method may further include using at least one natural language processing technique with respect to the company-specific textual data. The at least one natural language processing technique may include at least one from among a section parsing technique, a lemmatization technique, and a stop word removal technique.

The calculating of the respective first score based on a result of the first query may include using a heuristic technique to generate a raw natural language processing (NLP) score, and normalizing the raw NLP score to generate the respective first score.

The respective second plurality of sources that relate to company-specific revenue data may include line-item revenue data that relates to at least one company-specific regulatory filing.

The determining of the respective composite score may include multiplying the respective first score by a first weight, multiplying the respective second score by a second weight, and adding the weighted respective first score to the weighted respective second score.

According to another aspect of the present disclosure, a computing apparatus for facilitating a construction of a rank-ordered list of companies based on a theme is provided. The computing apparatus includes a processor, a memory, and a communication interface coupled to each of the processor and the memory. The processor is configured to: identify a plurality of companies, each company within the plurality of companies being associated with a respective tradable stock; determine, for each of the plurality of companies, a respective first plurality of sources that relate to company-specific textual data and a respective second plurality of sources that relate to company-specific revenue data; determine at least one search term that relates to the theme; use each of the determined at least one search term to query, for each of the plurality of companies, the respective first plurality of sources that relate to company-specific textual data; calculate, for each of the plurality of companies, a respective first score based on a result of the first query; use each of the determined at least one search term to query, for each of the plurality of companies, the respective second plurality of sources that relate to company-specific revenue data: calculate, for each of the plurality of companies, a respective second score based on a result of the second query; and determine, for each of the plurality of companies, a respective composite score based on a combination of the respective first score and the respective second score.

The processor may be further configured to determine, as the at least one search term, at least one single word that relates to the theme.

The processor may be further configured to determine, as the at least one search term, at least one two-word phrase that relates to the theme.

The processor may be further configured to determine, as the at least one search term, at least one three-word phrase that relates to the theme.

The processor may be further configured to augment the first query by determining a plurality of words that relate to the determined at least one search term, determining a plurality of phrases that relate to the determined at least one search term, determining a plurality of topics that relate to the determined at least one search term, and using the determined plurality of words, the determined plurality of phrases, and the determined plurality of topics to augment the query.

The processor may be further configured to use at least one natural language processing technique with respect to the determined plurality of words, the determined plurality of phrases, and the determined plurality of topics in order to augment the first query. The at least one natural language processing technique may include at least one from among a word association technique and a co-occurrence analysis technique.

The processor may be further configured to use at least one natural language processing technique with respect to the company-specific textual data. The at least one natural language processing technique may include at least one from among a section parsing technique, a lemmatization technique, and a stop word removal technique.

The processor may be further configured to calculate the respective first score by using a heuristic technique to generate a raw natural language processing (NLP) score, and normalizing the raw NLP score to generate the respective first score.

The respective second plurality of sources that relate to company-specific revenue data may include line-item revenue data that relates to at least one company-specific regulatory filing.

The processor may be further configured to determine the respective composite score by multiplying the respective first score by a first weight, multiplying the respective second score by a second weight, and adding the weighted respective first score to the weighted respective second score.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system for facilitating a construction of a thematic investment portfolio.

FIG. 2 illustrates an exemplary diagram of a network environment with a thematic investment portfolio construction device.

FIG. 3 shows an exemplary system for facilitating a construction of a thematic investment portfolio based on analysis of textual information and revenue data for candidate companies.

FIG. 4 is a flowchart of an exemplary process for facilitating a construction of a thematic investment portfolio based on analysis of textual information and revenue data for candidate companies.

FIG. 5 is a screenshot that illustrates an exemplary augmentation of a search term query.

FIG. 6 is a screenshot that illustrates an exemplary listing of companies that is rank-ordered based on a calculated thematic exposure score.

FIG. 7 is a screenshot that illustrates an exemplary output of a portfolio construction algorithm that includes a list of companies and associated weights within the portfolio.

FIG. 8 is a screenshot that illustrates an exemplary graphical depiction of a list of companies as a function of thematic exposure, portfolio weight, and time.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

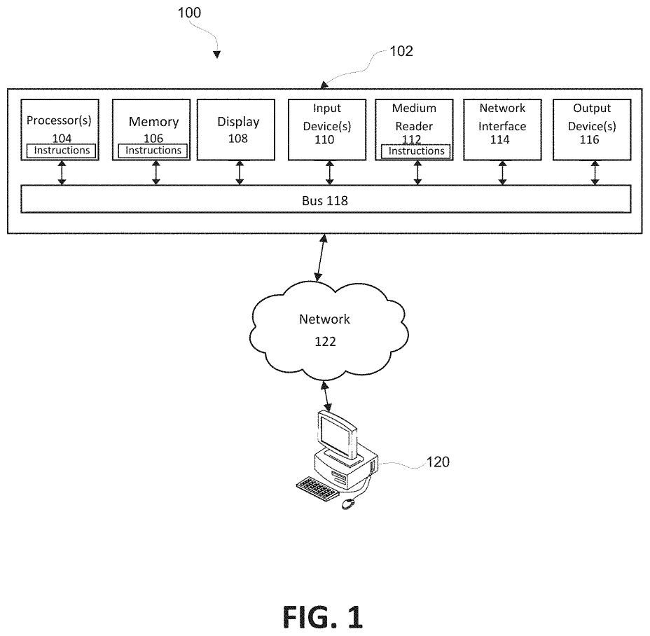

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a video display 108, such as a liquid crystal display (LCD), an organic light emitting diode (OLED), a flat panel display, a solid state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionality as described herein, and a processor described herein may be used to support a virtual processing environment.

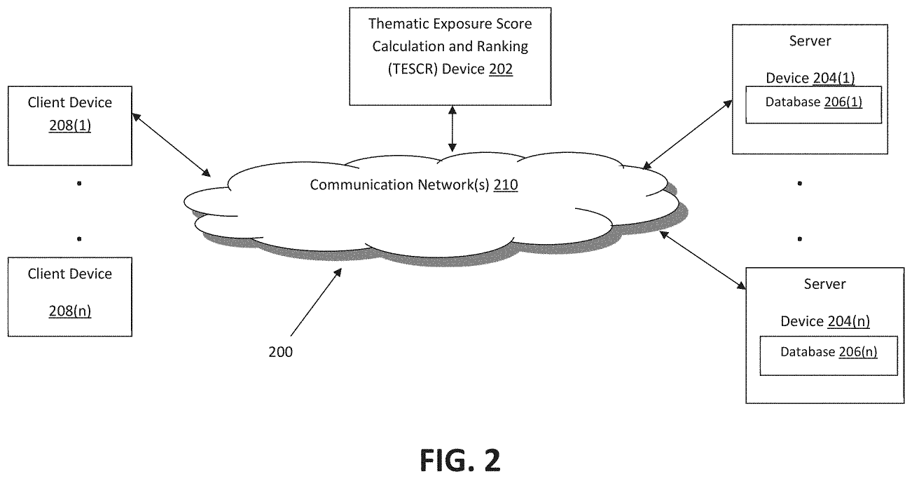

Referring to FIG. 2, a schematic of an exemplary network environment 200 for facilitating a construction of a thematic investment portfolio based on analysis of textual information and revenue data for candidate companies is illustrated. In this regard, a theme may relate to an emerging technology/business sector, a demographic shift, or a societal objective, such as, for example, renewable energy, clean water, or cybersecurity. By systematically analyzing the relevance of a company based on a theme in accordance with one or more exemplary embodiments as disclosed herein, an investor may speed the analysis process significantly, i.e., from many hours or days to just minutes, and may also be enabled to make informed decisions that are validated by data. Further, the inventive methodology described herein is scalable and applicable to many potential themes, which may focus on diverse market sectors.

The construction of a thematic investment portfolio may be facilitated by a Thematic Exposure Score Calculation and Ranking (TESCR) device 202. The TESCR device 202 may be the same or similar to the computer system 102 as described with respect to FIG. 1. The TESCR device 202 may store one or more applications that can include executable instructions that, when executed by the TESCR device 202, cause the TESCR device 202 to perform actions, such as to calculate a textual relevance score that relates to an association between a company and textual information with respect to the theme, calculate a revenue exposure score that relates to an exposure of a company to business segments that are relevant to the theme, and comparatively rank various companies based on the calculated scores, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the TESCR device 202 itself, may be located in virtual server(s) running in a cloud-based computing environment rather than being tied to one or more specific physical network computing devices. Also, the application(s) may be running in one or more virtual machines (VMs) executing on the TESCR device 202. Additionally, in one or more embodiments of this technology, virtual machine(s) running on the TESCR device 202 may be managed or supervised by a hypervisor.

In the network environment 200 of FIG. 2, the TESCR device 202 is coupled to a plurality of server devices 204(1)-204(n) that hosts a plurality of databases 206(1)-206(n), and also to a plurality of client devices 208(1)-208(n) via communication network(s) 210. A communication interface of the TESCR device 202, such as the network interface 114 of the computer system 102 of FIG. 1, operatively couples and communicates between the TESCR device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the TESCR device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and TESCR devices that efficiently facilitate constructions of thematic investment portfolios.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 202 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The TESCR device 202 may be a standalone device or integrated with one or more other devices or apparatuses, such as one or more of the server devices 204(1)-204(n), for example. In one particular example, the TESCR device 202 may include or be hosted by one of the server devices 204(1)-204(n), and other arrangements are also possible. Moreover, one or more of the devices of the TESCR device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the TESCR device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) host the databases 206(1)-206(n) that are configured to store resource usage data, historical performance metrics data, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can access the TESCR device. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example.

The client devices 208(1)-208(n) may run interface applications, such as standard web browsers or standalone client applications, which may provide an interface to communicate with the TESCR device 202 via the communication network(s) 210 in order to communicate resource usage data. The client devices 208(1)-208(n) may further include, among other features, a display device, such as a display screen or touchscreen, and/or an input device, such as a keyboard, for example.

Although the exemplary network environment 200 with the TESCR device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the TESCR device 202, the server devices 204(1)-204(n), or the client devices 208(1)-208(n), for example, may be configured to operate as virtual instances on the same physical machine. In other words, one or more of the TESCR device 202, the server devices 204(1)-204(n), or the client devices 208(1)-208(n) may operate on the same physical device rather than as separate devices communicating through communication network(s) 210. Additionally, there may be more or fewer TESCR devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

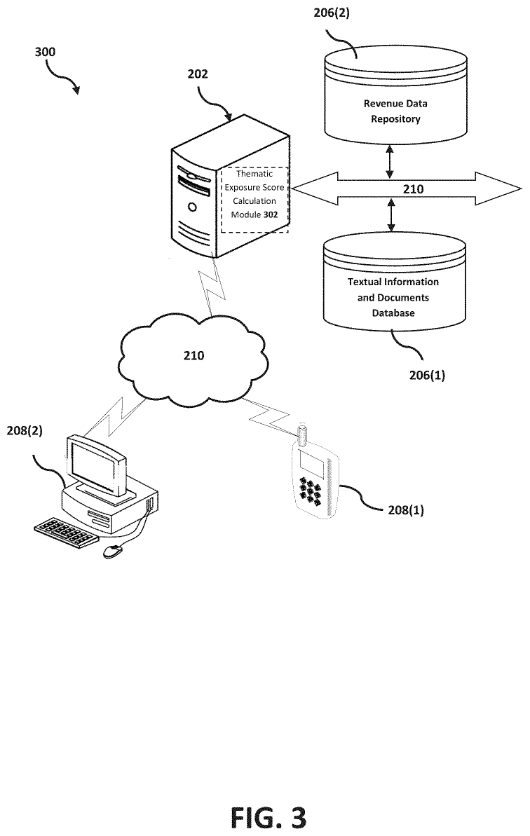

The TESCR device 202 is described and shown in FIG. 3 as including a thematic exposure score calculation module 302, although it may include other modules, databases, or applications, for example. As will be described below, the thematic exposure score calculation module 302 is configured to analyze textual information and company-specific revenue data to determine a company's degree of exposure to a theme. In this aspect, for each of a list of candidate companies, the thematic exposure score calculation module 302 calculates a textual relevance score, using, for example, a Natural Language Processing (NLP) methodology, that indicates a textual measure of the company's relevance with respect to the theme, and the module 302 also calculates a revenue exposure score that indicates a measure of how the company's revenues relate to the theme. The thematic exposure score calculation module then combines these two scores into a composite score, which is also referred to herein as a Thematic Exposure Score (TES). The companies are then rank-ordered based on their respective TES values, and the ordered rankings and scores are made available to appropriate personnel. The rank-ordered list may be used, for example, as an input for a purpose of constructing a portfolio.

An exemplary process 300 for facilitating construction of a thematic investment portfolio by utilizing the network environment of FIG. 2 is shown as being conducted in FIG. 3. Specifically, a first client device 208(1) and a second client device 208(2) are illustrated as being in communication with TESCR device 202. In this regard, the first client device 208(1) and the second client device 208(2) may be “clients” of the TESCR device 202 and are described herein as such. Nevertheless, it is to be known and understood that the first client device 208(1) and/or the second client device 208(2) need not necessarily be “clients” of the TESCR device 202, or any entity described in association therewith herein. Any additional or alternative relationship may exist between either or both of the first client device 208(1) and the second client device 208(2) and the TESCR device 202, or no relationship may exist.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the TESCR device 202 via broadband or cellular communication. The TESCR device 202 may access a textual information and documents database 206(1) and a revenue data repository 206(2). Of course, these embodiments are merely exemplary and are not limiting or exhaustive.

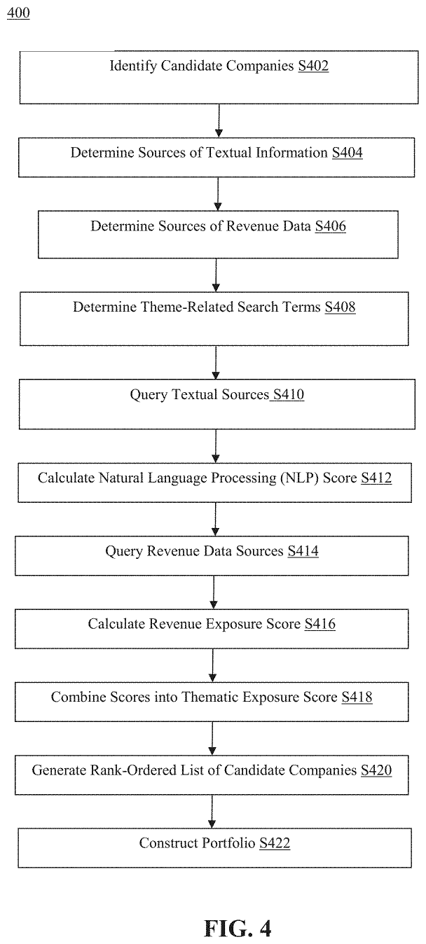

Upon being started, the thematic exposure score calculation module 302 executes a process for facilitating a construction of an investment portfolio based on a theme by analyzing textual information and revenue data for candidate companies. An exemplary process for facilitating a construction of a thematic investment portfolio is generally indicated at flowchart 400 in FIG. 4.

In the process 400 of FIG. 4, in step S402, a list of candidate companies is identified. The candidate companies may include any company having a stock that is available to be acquired and traded on an exchange and/or listed in an index, such as, for example, the Standard & Poor's (S&P) 500 index or the Morgan Stanley Capital International All Country World Index (MSCI ACWI).

At step S404, a set of sources of company-specific textual information is determined. Sources of textual information may include, for example, company self-descriptions, research notes, company earnings call transcripts, patents, information that is made available by news outlets, and/or textual information included in regulatory filings. The identified sources of textual information are then mapped to individual companies. In addition, traditional natural language processing techniques, such as section parsing, lemmatization, and stop word removal, may be performed on the textual information, in order to increase efficiency in data querying and analysis.

At step S406, a set of sources of company-specific revenue data is determined. Sources of revenue data may include, for example, line-item revenue from regulatory filings mapped to sector hierarchies (e.g., income statements contained in Form 10-K or Form 10-Q filings). The identified sources of revenue data are then mapped to the individual companies. For each company, a single company report or summary that includes all of the corresponding textual and revenue data may then be created.

At step S408, the set of theme-related search terms is determined. In an exemplary embodiment, a user may provide a search term as an input query, and the initial input query may be augmented by determining additional words, phrases, and/or topics that are related to the inputted search term. The augmentation of the query may be performed, for example, by using natural language processing (NLP) techniques, such as word association or co-occurrence analysis.

As an example, a user may utilize significant terms aggregation searches available in a search engine known as Elasticsearch, which provides a distributed, multitenant-capable full-text search engine with a web interface. In this manner, a separate search may be done for unigrams (single words), bigrams (two-word phrases) and trigrams (three-word phrases) based off of a foreground and background set. During this process, the foreground set may be defined as the set of documents containing the user's initial theme query, and the background set may include the rest of the stored documents. In this process, a term may be considered significant if there is a noticeable difference in the frequency of a unigram, bigram or trigram in the foreground set when compared to the background set. These significant terms may be given a score, for example, by using a method such as the Chi Squared method, whereby the independence of the occurrence of a unigram, bigram, or trigram in a document and the occurrence of the initial query in a document may be calculated. In this way, a high score indicates that the two cases described above are dependent, meaning that the occurrence of the unigram, bigram or trigram in a document increases the likelihood of the occurrence of the initial query in that document. These scores may be normalized, for example, by the number of documents containing the user's initial query, and may be filtered to remove rare and frequent words and phrases. Further, additional filtering, such as removing publisher-specific or company-specific jargon, may also be performed. In this way, the most relevant words and phrases may be presented to the user in order to augment the initial query. The user may then have an option to add to the query, delete elements of the query, or modify the final augmented query. In an exemplary embodiment, the user may be provided with suggestions for augmenting the query, whereby the user is free to accept or reject the suggestions.

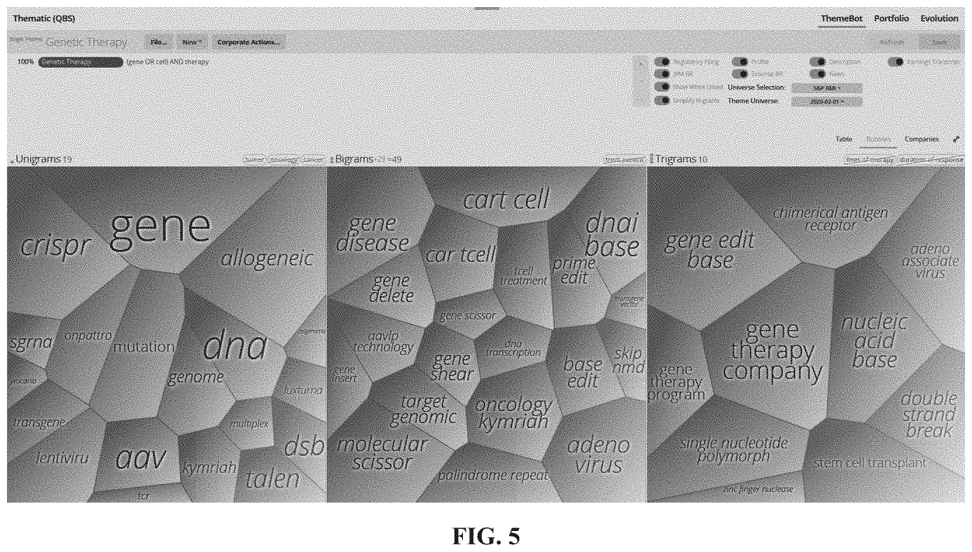

Referring to FIG. 5, a screenshot that illustrates an exemplary augmentation of a search term query. As shown in FIG. 5, a theme of “gene therapy” may be selected, and the initial query may include the logical construct: “(gene OR cell) AND therapy,” where OR refers to a union of results that include either search term, and AND refers to an intersection of results that include the corresponding search terms. Based on this initial query, the thematic exposure score calculation module 302 may use NLP techniques to augment the query to include a set of single words, or unigrams, i.e., one-word terms, that relate to the theme, such as “crispr,” “allogeneic,” “sgrna,” “onpattro,” “mutation,” “genome,” “dna,” “yescarta,” “zolgensma,” “transgene,” “lentivirus,” “aav,” “tcr,” “kymria,” “multiplex,” “talen,” “dsb,” and “luxturna.” Further, the thematic exposure score calculation module 302 may use NLP techniques to augment the query to also include a set of bigrams, i.e., two-word terms, that relate to the theme, such as “gene disease,” “cart cell,” “car tcell,” “tcell treatment,” “prime edit,” “dnai base,” “gene delete,” “gene scissor,” “transgene vector,” “gene insert,” “aavlp technology,” “gene shear,” “dna transcription,” “base edit,” “skip nmd,” “target genomic,” “oncology kymriah,” “molecular scissor,” “palindrome repeat,” and “adeno virus.” Still further, the thematic exposure score calculation module 302 may use NLP techniques to augment the query to also include a set of trigrams, i.e., three-word terms, that relate to the theme, such as “gene edit base,” “chimerical antigen receptor,” “adeno associate virus,” “gene therapy program,” “gene therapy company,” “nucleic acid base,” “double strand break,” “single nucleotide polymorph,” “zinc finger nuclease,” and “stem cell transplant.” The relative size of each term included in the augmented query may be based on a relevance of the term.

At step S410, the augmented query is applied to the determined set of textual sources, and at step S412, an NLP score is generated. In this aspect, the words and phrases included in the augmented query are used to generate an NLP score for each company by querying the indexed documents. In an exemplary embodiment, an NLP score may be determined by generating two scores, including a first score that is based on the initial query and a second score that is based on the additional words and phrases. To create the first score, all documents that contain the initial query search term may be returned. These documents may be given a score that is generated by using a method such as a term frequency-inverse document frequency (tf-idf) method, or by using a query tool such as Elasticsearch. This score may be normalized, for example, by the maximum score of all of the company's returned hits (i.e., successful search results).

To create the second score, all documents that contain the additional words and phrases may be returned. In an exemplary embodiment, this may be accomplished by returning all documents that satisfy one of the following criteria: 1) the document contains at least one unigram from the additional words and phrases if the initial query is a single word; 2) the document contains at least two unigrams from the additional words and phrases if the initial query is not a single word; 3) the document contains at least one bigram from the additional words and phrases; or 4) the document contains at least one trigram from the additional words and phrases.

These documents may then be given a textual relevance score that is equal to the sum of the scores of the additional words and phrases that exist in that document. In order to calculate a score per company, the documents from the above two queries may be grouped by company, and each company may be given an NLP score by using a heuristic, such as the following: 1) the mean of the document scores is calculated (scores_mean); 2) the standard deviation of the document scores is calculated (scores_std); 3) a “raw NLP” score is calculated by applying the following equation: scores_mean−0.5*(scores_std/sqrt(number of documents); and 4) a “final NLP” score is calculated by first calculating the rank percentile of the raw NLP score and then setting the final NLP score to be zero in cases where the rank percentile is equal to the lowest rank percentile value. The final NLP score is thus normalized to a range from 0 to 100.

In an exemplary embodiment, the thematic exposure score calculation module 302 will be able to understand and categorize the opinions expressed in any particular textual document, specifically in order to ascertain whether the theme-related coverage is positive, negative or neutral. This sentiment-dependent processing of individual documents may affect the company-level aggregated textual relevance score.

At step S414, the augmented query is applied to the determined set of revenue data sources, and at step S416, a revenue exposure score is calculated. In an exemplary embodiment, the revenue score may be obtained by matching the augmented query against a textual description of company revenues. In some instances, line-item descriptions of revenues may be very concise and specific, and in this aspect, a multi-level industry hierarchy, within which the lowest level is most generic (e.g. “Business Services”) and the highest level is most specific (e.g. “Media and Printing Services”), may be used to standardize and generalize. A classifier, such as a Lasso-regularized linear model, may be used to identify a company's thematic revenue exposure.

In an exemplary embodiment, the revenue exposure score may be determined by training a Logistic Regression classifier, for which a single piece of training data would be a label, and the counts of a single company's revenue line items across the different industries at some level of the revenue hierarchy are tallied. For example, if the fifth level of the hierarchy is chosen to be used as features for the model and the revenue hierarchy had only three industries at level 5, including “International Water Utilities,” “Europe Wholesale Power,” and “Internet Support Services,” and a particular company had three revenue items mapped to “International Water Utilities” and one revenue item mapped to “Europe Wholesale Power,” then its feature vector would be [3,1,0]. The feature vector may then be combined with a label in order to determine a single piece of training data for the model.

To obtain positive training examples (e.g., examples of companies for which revenue line items are related to the initial user query), the database of revenue data may be queried by using the user's initial query and the additional words and phrases. In an exemplary embodiment, this may be accomplished by querying all revenue line items as follows: 1) the revenue line item contains the initial query; 2) the revenue line item contains at least one unigram from the additional words and phrases if the initial query is a single word; 3) the revenue line item contains at least two unigrams from the additional words and phrases if the initial query is not a single word; 4) the revenue line item contains at least one bigram from the additional words and phrases; or 5) the revenue line item contains at least one trigram from the additional words and phrases.

Negative training samples may also be sourced via the database of revenue data by, for example, excluding any companies for which line items were retrieved when obtaining positive examples and matching the distribution of the positive samples at some lower level of revenue hierarchy multiplied by some size parameter. All other line items for each company in the training set may then be queried; and, as previously described, each company in the training set can be transformed into a feature vector of its counts of revenue line items across the different industries at the selected level of the revenue hierarchy.

A revenue score for each company may then be determined by using a heuristic, such as the following: if the company is a positive training example, it is given a score of one (1); if the company is not a positive training example, but has a least one revenue item mapped to the selected revenue hierarchy level name in the model's features, that company is given a score predicted by the model that is adjusted by the model's out-of-sample precision, e.g., as determined by predicting the labels of training examples; and all other companies are given a score of zero (0).

At step S418, the NLP score is combined with the revenue exposure score to form a composite score that may be referred to as a thematic exposure score. In an exemplary embodiment, the thematic exposure score may be equal to a simple average of the NLP score and the revenue exposure score, and thus may be calculated by adding the NLP score to the revenue exposure score and then dividing by two. In another exemplary embodiment, the thematic exposure score may be calculated by multiplying the NLP score by a first weight, multiplying the revenue exposure score by a second weight, and then adding together the weighted scores.

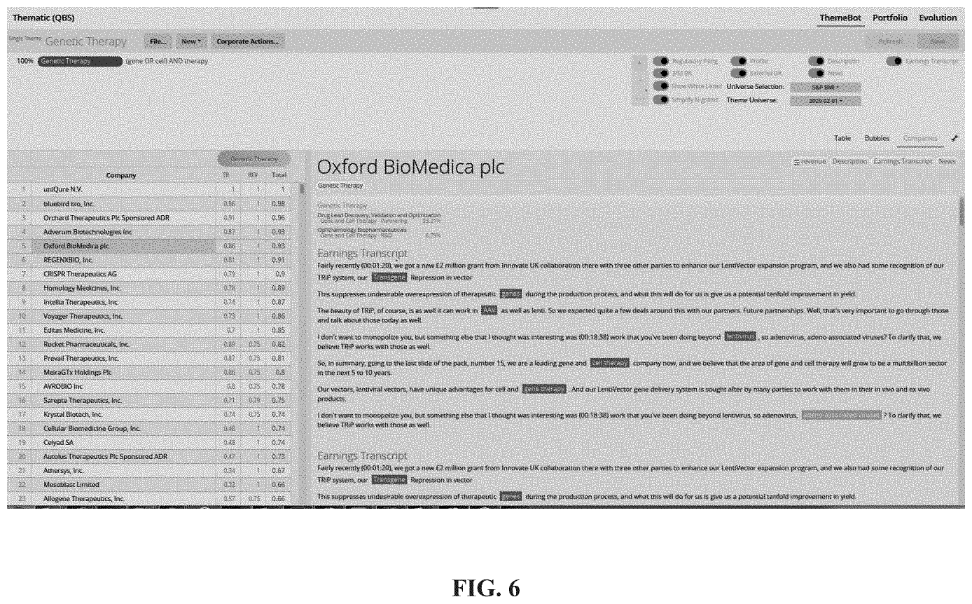

At step S420, a rank-ordered list of the candidate companies is generated. The ranked order is determined based on the thematic exposure score. Referring to FIG. 6, a screenshot that illustrates an exemplary listing of companies that is rank-ordered based on a calculated thematic exposure score is shown. In an exemplary embodiment, the rank-ordered list may be displayed on a client device 208, and the list may also show each of the NLP score, the revenue exposure score, and the composite thematic exposure score for each listed company. Further, the display may enable a user to obtain a detailed list of information that relates to a particular company included in the list by clicking on that company. For example, as shown in FIG. 6, by clicking the highlighted entry for “Oxford BioMedica plc” on the left side of the display screen, a listing of relevant information that relates to the selected company is displayed on the right side of the screen. Then, at step S422, the rank-ordered list may be used as a basis for constructing a portfolio.

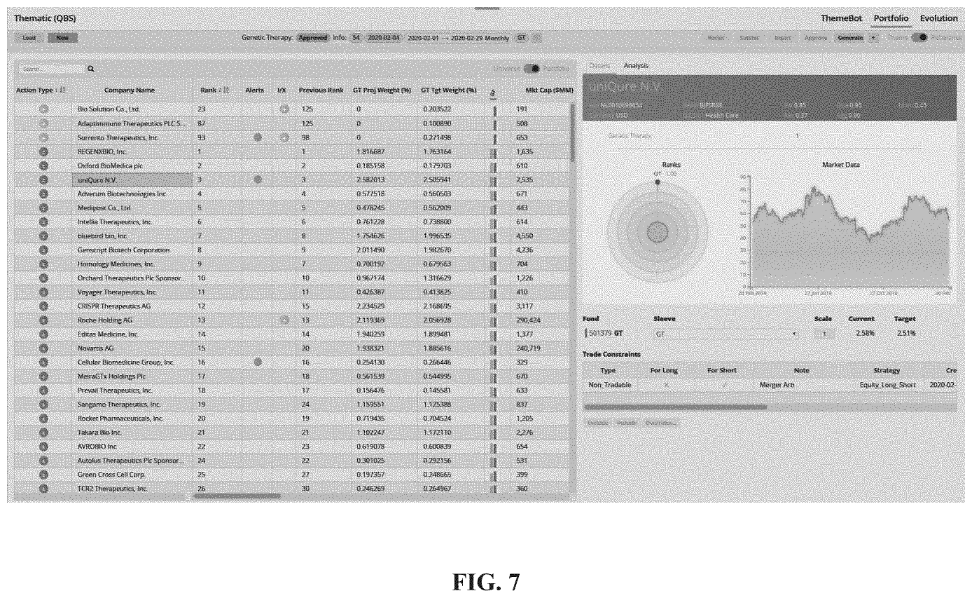

FIG. 7 is a screenshot that illustrates an exemplary output of a portfolio construction algorithm that includes a list of companies and associated weighted scores within the portfolio. In the list shown in FIG. 7, the list of companies is rank-ordered based on the corresponding relevance of each company within the portfolio. In an exemplary embodiment, a thematic investment portfolio may include various amounts of stocks of companies that are included in the list of candidate companies shown in FIG. 6. The weights are highly variable, and a user may choose to include any amount of a given stock based on any desired criteria. In this regard, the thematic exposure score provides relevant information to the user, and the user may utilize this information in conjunction with other information, such as market data and other information that relates to the projected value of the stock, in determining, for example, a relative weight for each stock within the portfolio. In an exemplary embodiment, the portfolio weights for individual names would be subject to tradability and liquidity constraints. Further, additional criteria for determining a weight may include, for example, analyst forecasts, company fundamental information based on finance statements, security liquidity, market capitalization, other market data such as financial ratios, and/or various factor scores.

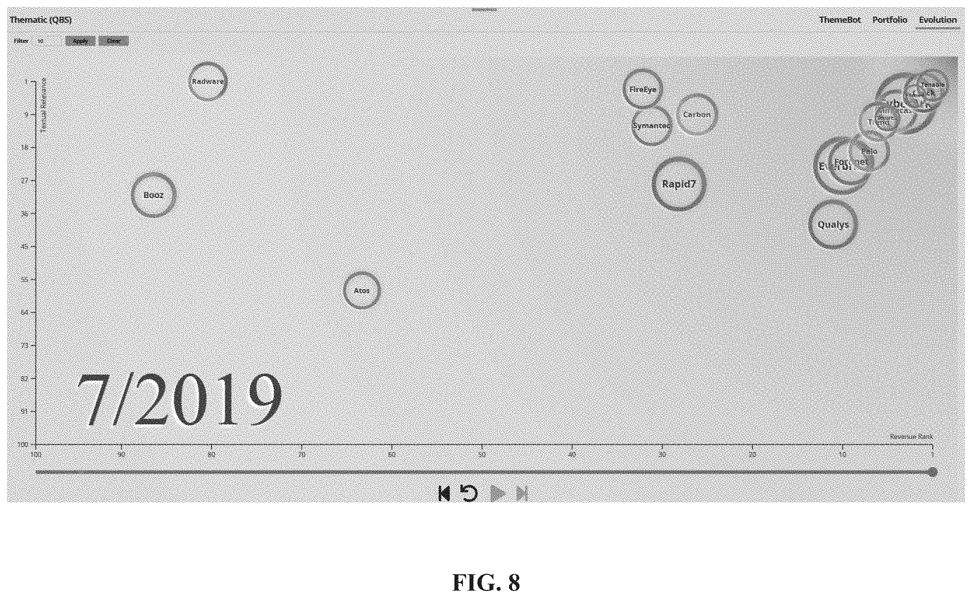

FIG. 8 is a screenshot that illustrates an exemplary graphical depiction of a list of companies as a function of thematic exposure and portfolio weight. As illustrated in FIG. 8, each company is shown as a circle for which the radius indicates the portfolio weight of its stock within the portfolio. The x-axis corresponds to the revenue exposure score ranking for each company, and the y-axis correspond to the textural relevance score ranking for each company. Thus, in the graph shown in FIG. 8, a user can see that when a relatively large circle is positioned near the top right corner of the graph, this is reflective of a high correlation between the portfolio weight and the portfolio theme. Further, a user can use this graph to see how the portfolio composition and the individual weights of companies evolve over time to validate that relevant stocks are captured in a timely and efficient manner, and to confirm that the TES signal is stable and that the portfolio is tradable.

Accordingly, with this technology, an optimized process for facilitating a construction of a thematic investment portfolio provided. The optimized process calculates a textual relevance score and a revenue exposure score and then combines these into a thematic exposure score that indicates a degree of relevance of a particular company to the selected theme, and provides a rank-ordered list of companies that can be used to construct a thematic investment portfolio.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims. Further, although the invention has been described with respect to particular embodiments with respect to determining textual relevance and revenue relevance, various approaches to determining textual relevance and revenue relevance are contemplated, and as such, are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for facilitating a construction of a rank-ordered list of companies based on a theme, the method comprising:
identifying a plurality of companies, each company within the plurality of companies being associated with a respective tradable stock;
determining, for each of the plurality of companies, a respective first plurality of sources that relate to company-specific textual data and a respective second plurality of sources that relate to company-specific revenue data;
determining at least one search term that relates to the theme;
using each of the determined at least one search term to query, for each of the plurality of companies, the respective first plurality of sources that relate to company-specific textual data;
calculating, for each of the plurality of companies, a respective first score based on a result of the first query;
using each of the determined at least one search term to query, for each of the plurality of companies, the respective second plurality of sources that relate to company-specific revenue data;
calculating, for each of the plurality of companies, a respective second score based on a result of the second query; and
determining, for each of the plurality of companies, a respective composite score based on a combination of the respective first score and the respective second score.

2. The method of claim 1, wherein the determining of at least one search term that relates to the theme includes determining at least one single word that relates to the theme.

3. The method of claim 1, wherein the determining of at least one search term that relates to the theme includes determining at least one two-word phrase that relates to the theme.

4. The method of claim 1, wherein the determining of at least one search term that relates to the theme includes determining at least one three-word phrase that relates to the theme.

5. The method of claim 1, further comprising augmenting the first query by determining a plurality of words that relate to the determined at least one search term, determining a plurality of phrases that relate to the determined at least one search term, determining a plurality of topics that relate to the determined at least one search term, and using the determined plurality of words, the determined plurality of phrases, and the determined plurality of topics to augment the query.

6. The method of claim 5, further comprising using at least one natural language processing technique with respect to the determined plurality of words, the determined plurality of phrases, and the determined plurality of topics in order to augment the first query, wherein the at least one natural language processing technique includes at least one from among a word association technique and a co-occurrence analysis technique.

7. The method of claim 1, further comprising using at least one natural language processing technique with respect to the company-specific textual data, wherein the at least one natural language processing technique includes at least one from among a section parsing technique, a lemmatization technique, and a stop word removal technique.

8. The method of claim 1, wherein the calculating of the respective first score based on a result of the first query includes using a heuristic technique to generate a raw natural language processing (NLP) score, and normalizing the raw NLP score to generate the respective first score.

9. The method of claim 1, wherein the respective second plurality of sources that relate to company-specific revenue data includes line-item revenue data that relates to at least one company-specific regulatory filing.

10. The method of claim 1, wherein the determining of the respective composite score includes multiplying the respective first score by a first weight, multiplying the respective second score by a second weight, and adding the weighted respective first score to the weighted respective second score.

11. A computing apparatus for facilitating a construction of a rank-ordered list of companies based on a theme, the computing apparatus comprising:
a processor;
a memory; and
a communication interface coupled to each of the processor and the memory,
wherein the processor is configured to:
identify a plurality of companies, each company within the plurality of companies being associated with a respective tradable stock;
determine, for each of the plurality of companies, a respective first plurality of sources that relate to company-specific textual data and a respective second plurality of sources that relate to company-specific revenue data;
determine at least one search term that relates to the theme;
use each of the determined at least one search term to query, for each of the plurality of companies, the respective first plurality of sources that relate to company-specific textual data;
calculate, for each of the plurality of companies, a respective first score based on a result of the first query;
use each of the determined at least one search term to query, for each of the plurality of companies, the respective second plurality of sources that relate to company-specific revenue data;
calculate, for each of the plurality of companies, a respective second score based on a result of the second query; and
determine, for each of the plurality of companies, a respective composite score based on a combination of the respective first score and the respective second score.

12. The computing apparatus of claim 11, wherein the processor is further configured to determine, as the at least one search term, at least one single word that relates to the theme.

13. The computing apparatus of claim 11, wherein the processor is further configured to determine, as the at least one search term, at least one two-word phrase that relates to the theme.

14. The computing apparatus of claim 11, wherein the processor is further configured to determine, as the at least one search term, at least one three-word phrase that relates to the theme.

15. The computing apparatus of claim 11, wherein the processor is further configured to augment the first query by determining a plurality of words that relate to the determined at least one search term, determining a plurality of phrases that relate to the determined at least one search term, determining a plurality of topics that relate to the determined at least one search term, and using the determined plurality of words, the determined plurality of phrases, and the determined plurality of topics to augment the query.

16. The computing apparatus of claim 15, wherein the processor is further configured to use at least one natural language processing technique with respect to the determined plurality of words, the determined plurality of phrases, and the determined plurality of topics in order to augment the first query, wherein the at least one natural language processing technique includes at least one from among a word association technique and a co-occurrence analysis technique.

17. The computing apparatus of claim 11, wherein the processor is further configured to use at least one natural language processing technique with respect to the company-specific textual data, wherein the at least one natural language processing technique includes at least one from among a section parsing technique, a lemmatization technique, and a stop word removal technique.

18. The computing apparatus of claim 11, wherein the processor is further configured to calculate the respective first score by using a heuristic technique to generate a raw natural language processing (NLP) score, and normalizing the raw NLP score to generate the respective first score.

19. The computing apparatus of claim 11, wherein the respective second plurality of sources that relate to company-specific revenue data includes line-item revenue data that relates to at least one company-specific regulatory filing.

20. The computing apparatus of claim 11, wherein the processor is further configured to determine the respective composite score by multiplying the respective first score by a first weight, multiplying the respective second score by a second weight, and adding the weighted respective first score to the weighted respective second score.
